(19) United States
(12) Patent Application Publication
(10) Pub. No.: US 2025/0256340 A1
(43) Pub. Date: Aug. 14, 2025

(54) TRACK CONNECTOR FOR A CUTTING SAW TRACK GUIDE

(71) Applicant: Evolution Power Tools Limited, Sheffield (GB)

(72) Inventors: Simon DONSON, Sheffield (GB); Harry GREEN, Sheffield (GB); Elvis XU, Sheffield (GB)

(21) Appl. No.: 19/046,925

(22) Filed: Feb. 6, 2025

(30) Foreign Application Priority Data
Feb. 8, 2024 (GB) 2401751.9

(51) Int. Cl. B23D 47/02

(52) U.S. Cl. CPC B23D 47/02; B23Q 2240/002

(57) ABSTRACT

A track guide for a cutting saw power tool allows the saw to slide along a track. The guide has two track sections, each with longitudinal channels. A track connector joins these sections. The connector has an elongated body with portions fitting into the channels of each track section. A rotary securing element on the connector has a cam profile and can rotate between two positions. In the first position, the connector moves freely within the channels. In the second position, the element engages the channel walls, locking the connector and securing the track sections together.

### SUMMARY

The present invention relates to a track connector for a cutting saw track guide and a cutting saw track guide. More particularly, the present invention relates to an improved track connector for connecting track sections of a track guide for a cutting saw power tool.

Cutting saw track guides enable accurate, straight long cuts to be made. A track-adapted cutting saw is more convenient and space-efficient than a table saw and the use of track-adapted cutting saws enables materials such as aluminium sheet, mild steel plate, plastics, wood, plywood and MDF, as well as doors and decorative panels, to be cut in lengths up to around 3 m in some configurations.

However, assembly and connection of tracks can be problematic. Conventional methods such as the use of screws or bolts are cumbersome to assemble and disassemble and may cause damage to the track sections over time. A solution is needed which enables quick and efficient assembly whilst providing a sufficiently robust structure to support cutting of materials using track-adapted cutting saw power tool.

The present invention seeks, in embodiments, to address these known disadvantages.

According to a first aspect of the present invention, there is provided A track guide for a cutting saw power tool, the track guide being arranged in use to engage with a cutting saw power tool such that the cutting saw power tool is operable to slide back and forth in a longitudinal direction along the track, the track guide comprising: first and second track sections, each track section having at least one longitudinal channel arranged substantially parallel to the longitudinal direction; and at least one track connector, the or each track connector comprising an elongate main body configured and arranged such that, in use, a first portion of the elongate main body is received within a longitudinal channel of the first track section and a second portion of the elongate main body of the track member is received within a corresponding longitudinal channel of the second track section in order to connect the first and second track sections in a longitudinal direction; wherein each track connector comprises at least one rotary securing element comprising an engagement portion having a cam profile, wherein the or each rotary securing element is selectively rotatable about an axis of rotation between a first rotational orientation in which the track connector is free to move with respect to the respective longitudinal channel and a second rotational orientation in which the track connector is releasably engaged with one or more walls of a respective channel such that the track connector is held within the respective channel.

In one embodiment, the first and second rotational orientations are angularly spaced by 90 degrees or less.

In one embodiment, the engagement portion of the or each rotary securing element is spaced from one or more walls of the respective channel in the first rotational orientation. In one embodiment, the engagement portion of the or each rotary securing element is configured and arranged to engage directly with one or more of the walls of the respective channel in the second rotational orientation.

In one embodiment, the engagement portion of the or each rotary securing element is configured and arranged to engage directly with two opposing walls of the respective channel in the second rotational orientation.

In one embodiment, the elongate main body comprises first and second portions, and wherein the engagement portion of the or each rotary securing element is operable, in the second rotational orientation, to cause the first and second portions to engage with one or more of the walls of the respective channel.

In one embodiment, the engagement portion of the or each rotary securing element has a cam profile having rotational symmetry of the order of one or two.

In one embodiment, the engagement portion of the or each rotary securing element has an elliptical cam profile.

In one embodiment, the engagement portion of the or each rotary securing element has a circular cam profile having a centre offset from the axis of rotation of the respective rotary securing element.

In one embodiment, the or each rotary securing element is located in a respective recess formed in the elongate main body.

In one embodiment, a plurality of rotary securing elements are provided on each track connector.

In one embodiment, four rotary securing elements are provided on each track connector.

According to a second aspect of the present invention, there is provided a track connector for connection of first and second sections of a track guide for a cutting saw power tool, the track guide being arranged in use to engage with a cutting saw power tool such that the cutting saw power tool is operable to slide back and forth in a longitudinal direction along the track guide, the first and second track sections each having at least one longitudinal channel arranged substantially parallel to the longitudinal direction, wherein the track connector comprises: an elongate main body configured and arranged such that, in use, a first portion of the elongate main body is received within a longitudinal channel of the first track section and a second portion of the elongate main body is received within a corresponding longitudinal channel of the second track section in order to connect the first and second track sections in a longitudinal direction; and at least one rotary securing element comprising an engagement portion having a cam profile, the or each rotary securing element being selectively moveable between a first rotational orientation in which, in use, the track connector is free to move with respect to the respective longitudinal channel and a second rotational orientation in which, in use, the track connector is releasably engaged with a sidewall of a respective channel such that the track connector is held within the respective channel.

In one embodiment, the first and second rotational orientations are angularly spaced by 90 degrees or less.

In one embodiment, the engagement portion of the or each rotary securing element is spaced from one or more walls of the respective channel in the first rotational orientation.

In one embodiment, the engagement portion of the or each rotary securing element is configured and arranged to engage directly with one or more of the walls of the respective channel in the second rotational orientation.

In one embodiment, the engagement portion of the or each rotary securing element is configured and arranged to engage directly with two opposing walls of the respective channel in the second rotational orientation.

In one embodiment, the elongate main body comprises first and second portions, and wherein the engagement portion of the or each rotary securing element is operable, in the second rotational orientation, to cause the first and second portions to engage with one or more of the walls of the respective channel.

In one embodiment, the engagement portion of the or each rotary securing element has a cam profile having rotational symmetry of the order of one or two.

In one embodiment, the engagement portion of the or each rotary securing element has an elliptical cam profile.

In one embodiment, the engagement portion of the or each rotary securing element has a circular cam profile having a centre offset from the axis of rotation of the respective rotary securing element.

In one embodiment, the or each rotary securing element is located in a respective recess formed in the elongate main body.

In one embodiment, a plurality of rotary securing elements are provided on each track connector.

In one embodiment, four rotary securing elements are provided on each track connector.

### BRIEF DESCRIPTION OF FIGURES

Embodiments of the invention will now be described with reference to the following figures in which:

FIG. 1 shows a front perspective view of a track saw arrangement comprising a cutting saw power tool and a track guide according to an embodiment of the present invention;

FIG. 2 shows front perspective view of a track guide according to an embodiment;

FIG. 3 shows a top plan view of the track guide of FIG. 2;

FIG. 4 shows an underside plan view of the track guide of FIG. 2;

FIG. 5 shows a front view of the track guide and cutting saw power tool illustrating the engagement therebetween;

FIG. 6 shows a perspective view of a track connector according to a first embodiment of the present invention;

FIG. 7 shows a detailed view of a part of the track connector of FIG. 6;

FIG. 8 shows a plan view of a securing element forming part of the track connector of FIGS. 6 and 7;

FIG. 9 shows a perspective view of the securing element of FIG. 8;

FIG. 10 shows a plan view of the securing element of FIG. 8 in a first rotational position in use;

FIG. 11 shows a plan view of the securing element of FIG. 8 in a second rotational position in use;

FIGS. 12A to 12D show examples of different forms of securing element according to embodiments of the invention;

FIG. 13 shows a perspective view of a track connector according to a second embodiment of the present invention; and

FIG. 14 shows an exploded view of the components of the track connector of FIG. 13.

### DETAILED DESCRIPTION

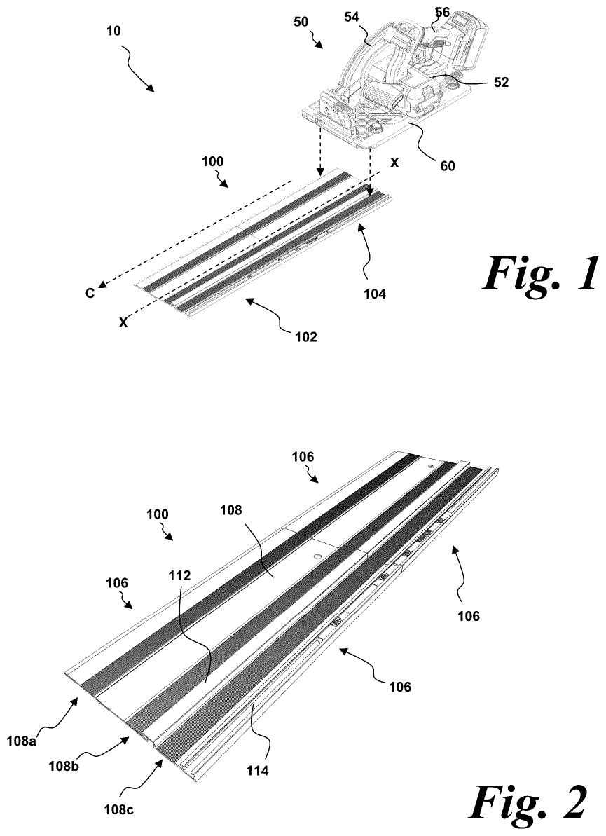

FIG. 1 shows a track saw arrangement 10. The track saw arrangement 10 comprises a cutting saw power tool 50 and a track guide 100 according to an embodiment.

The cutting saw power tool 50 is, in embodiments, in the form of a circular saw 50. However, this is not to be taken as limiting and any cutting saw suitable for track use and performing long straight cuts may be used, for example, other types of circular saw, jigsaws or routers may be used with the present invention.

The circular saw 50 is arranged to engage with the track guide 100 and slide there along in a longitudinal cutting direction C parallel to a longitudinal axis X-X of the track guide 100. The circular saw 50 comprises a main body 52, comprising a blade housing 54 and a handle arrangement 56. A circular saw blade 58 (FIG. 5) is contained within the blade housing 54. A base 60 of the circular saw 50 is shaped and configured to engage with the track guide 100.

The track guide 100 comprises first and second track sections 102, 104. In embodiments, each track section 102, 104 has the same configuration and is interchangeable. However, this is not to be taken as limiting and the sections may in principle be different in structure provided they can be connected to form a continuous length of track. For example, connectable track sections 102, 104 may be the same length or have different lengths. In specific embodiments, track sections 102, 104 may have lengths of 330, 700 and 1400 mm. However, these are not to be taken as limiting and any suitable length of track section may be used.

In addition, although only two track sections 102, 104 are shown, this is not to be taken as limiting and any number of track sections may be connected together to form any suitable length of track.

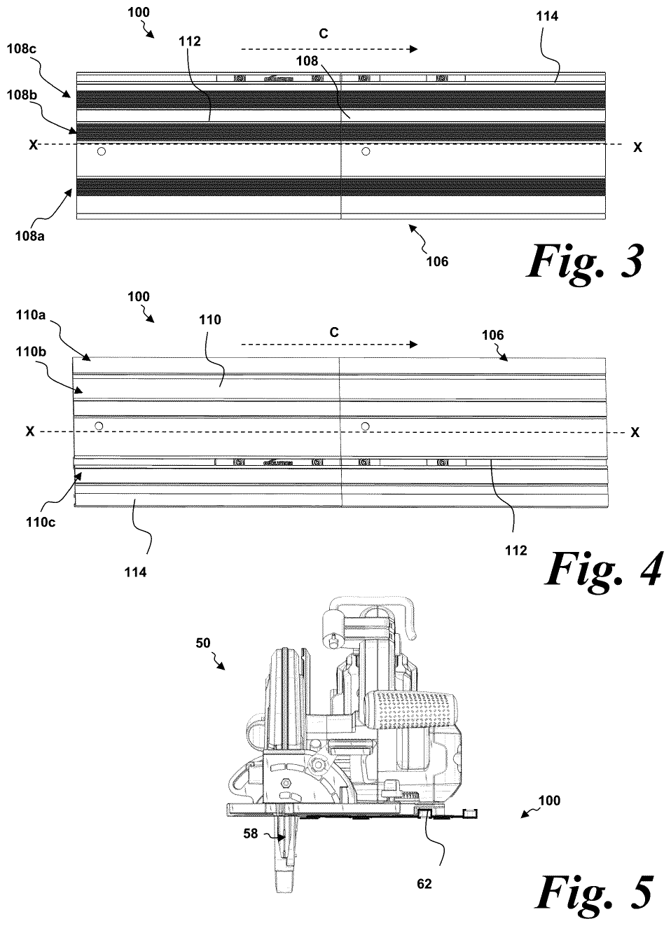

FIGS. 2 to 5 show the track guide 100 in more detail. FIG. 2 shows a perspective view of the track guide 100 comprising first and second track sections 102, 104 connected to one another. FIGS. 3 and 4 show a top view and a lower view of the track guide 100 shown in FIG. 2. FIG. 5 shows a front view of the track guide 100 and cutting saw 50 engaged with one another as would typically be the case during a cutting operation.

As shown in FIGS. 2 to 4, each track section 102, 104 comprises a main body 106 formed, in embodiments, from extruded aluminium. However, any other suitable metal or forming process may be used. The main body 106 has a constant cross-sectional profile parallel to the longitudinal axis X-X. The main body 106 has an upper surface 108 which is generally planar and upon which the cutting saw 50 can slide in the longitudinal direction C in use, and a lower surface 110 for engagement with a suitable support surface (not shown).

Longitudinal guide strips 108a, 108b, 108c are formed on the upper surface 108. The guide strips 108a, 108b, 108c may be formed from any suitable material. In embodiments, the guide strips 108a, 108b, 108c are formed from a low friction resistance hard plastics material and comprise longitudinal strakes parallel to the longitudinal axis X-X. This configuration allows the cutting saw 50 to slide back and forth easily on the track guide 100. The guide strips 108a, 108b, 108c are configured and arranged to enable the cutting saw 50 to slide easily along the track sections 102, 104 without damage such as scratching or grazing.

In embodiments, longitudinal strips 110a, 110b, 110c are provided on the lower surface 110. Strip 110a comprises a sacrificial edge upon which the cutting saw 50 is guided in use. Strip 110a is formed from a material such as ABS. Longitudinal strips 110b, 110c form gripping elements to enable the track guide 100 to remain stationary on a support surface and not slide. Strips 110b, 110c may be formed from neoprene or ethylene propylene diene terpolymer (EPDM).

Two raised channels 112, 114 are provided in the main body 106 which extend parallel to the longitudinal axis X-X. Each channel 112, 114 has a constant cross section in the longitudinal direction X-X and is open at each end and on either an upper or a lower side thereof.

Channel 112 is delimited by three channel walls and has a longitudinal opening in the lower surface 110 of the main body 106. The channel 112 is also delimited by three channel walls and has a longitudinal opening on the upper surface 108 of the main body 106. A narrow flange or lip delimits the longitudinal opening of each channel 112, 114 and forms a perpendicular extension or lip attached to the adjacent wall for each channel 112. 114. In embodiments, the channels 112, 114 have a width of approximately 12-13 mm.

However, the described embodiment is non-limiting and any suitable arrangement of channels 112, 114 may be used. For example, channels 112, 114 may, in embodiments, both have openings in the upper surface 108 or both channels 112, 114 may have both openings in the lower surface 110. The channels 112, 114 may be placed in any suitable spatial relationship to one another. For example, they may be closer together or further apart than shown in this embodiment. In addition, further channels 112, 114 may be provided if required.

Both channels 112, 114 form elongate raised portions of the upper surface 108 as shown in FIG. 2. A feature of this is shown in FIG. 5. FIG. 5 shows a front view (i.e. head on towards the cutting saw along the axis X-X) of the cutting saw 50 in situ on the track guide 100.

As shown, the channel 112 engages with a complementary longitudinal recess 62 formed in the base 60 of the cutting saw 50. When the cutting saw 50 is placed on the track guide 100, the recess 62 engages with the channel 112. In addition, a sidewall 118 of the main body 106 is located adjacent the blade housing 54 of the cutting saw 50. These two engagements enabled the cutting saw 50 to slide back and forth along the axis X-X in the cutting direction without deviation.

The channels 112, 114 facilitate connection of the track sections 102, 104 as will be described below. In embodiments, the track sections 102, 104 are separate components and require connection. Whilst they comprise complimentary abutment surfaces at the end of each track section 102, 104, it is necessary for a connector to be used to secure the track sections 102, 104 together.

To achieve this, a track connector 150 is provided. In specific embodiments, two track connectors are used to secure the track sections 102, 104 together.

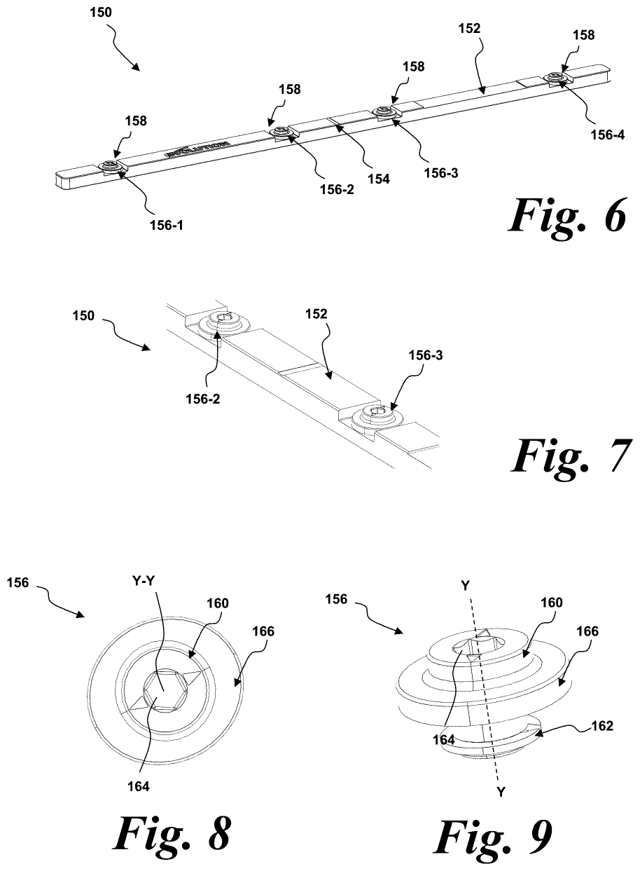

A first embodiment of a track connector 150 is shown in FIG. 6. Connectors 150 are also shown in FIGS. 1 to 5. As shown, the track connector 150 comprises a generally elongate body 152 having a rectangular cross section. The elongate body 152 is formed from a suitable material such as metal (for example, steel or aluminium) or a plastics material. However, any suitable material may be used.

The elongate body 152 of the track connector 150 is dimensioned and arranged to fit slidably within one of the channels 112, 114 as shown in FIGS. 1 to 5. By slidably fitted within a channel 112, 114 is meant that the track connector 150 is dimensioned and arranged such that it is smaller in cross section than the channels 112, 114 such that the track connector 150 may slide back and forth within the channel(s) 112, 114 without significant force being required, i.e. the fit is not frictional.

In addition, the track connector 150 is dimensioned and arranged such that there is relatively little play when within a channel 112, 114. In embodiments, the dimensions of the cross-section of the elongate body 152 of the track connector 150 and the width of each channel 112, 114 are selected to enable ease of fitment of the track connector 150 in a channel 112, 114 without excess play.

To achieve this, the track connector 150 may have a width which is 2 mm or less than the width of the respective channel 112, 114. In embodiments, the track connector 150 may have a width which is 1.5 mm less than the width of the respective channel 112, 114. In specific embodiments, the track connector 150 has a width of 11.5 mm and the channel 112, 114 may have a width between 11.8 mm and 12.8 mm.

In use, one end of a track connector 150 is inserted into a channel 112, 114 of the first track section 102 and an opposite end of the track connector 150 is inserted into a corresponding channel 112, 114 of the second track section 104. A marker 154 is formed in the elongate body 152 of the track connector 150 to indicate a halfway point at which the two track sections 102, 104 should meet.

In order to secure the track sections 102, 104 to one another, the track connector 150 must be of sufficient length to provide necessary structural support and strength to ensure that the two track sections 102, 104 do not flex relative to one another and can support the load of the cutting saw 50 moving there along. In embodiments, the track connector 150 may have an overall length in the region of 300-400 mm. In specific embodiments, the track connector 150 has an overall length of 320 mm.

However, because the track connector 150 is slidably received in a channel 112, 114 for convenience of assembly, it is necessary to further secure the track connector 150 within a channel 112, 114 so that each track section 102, 104 is prevented from moving relative to one another in a direction parallel to the axis X-X, and so that the track sections 102, 104 are robustly retained as a unit without significant play therebetween.

To achieve this, securing elements 156 are provided along the length of the track connector 150. In embodiments four securing elements 156-1, 156-2, 156-3, 156-4 are provided on each track connector 150. However, any suitable number of securing elements may be provided as required.

FIG. 7 shows an enlarged view of two securing elements 156-2, 156-3. In embodiments, the securing elements 156-1, 156-2, 156-3, 156-4 are located within recesses 158 formed in the upper and side surfaces of the elongate body 152 of the track connector 150. The recesses 158 are dimensioned and arranged such that the securing elements 156-1, 156-2, 156-3, 156-4 do not extend beyond the upper surface of the elongate body 152.

The securing elements 156-1, 156-2, 156-3, 156-4 comprise rotary securing elements 156-1, 156-2, 156-3, 156-4 which are operable to rotate in use. The securing elements 156-1, 156-2, 156-3, 156-4 are shown removed from the remainder of the track connector 150 in FIGS. 8 and 9.

As shown in these figures, the securing elements 156 each comprise a cylindrical main body 160 having an axis of rotation Y-Y. A concentric fixing element 162 is connected at the base of the main body 160 which enables the securing element 156 to be connected to the elongate main body 152 of the track connector 150. In embodiments, the main body 160 extends through a through hole (not shown) located in the recess 158 in the elongate main body 152, and the fixing element 162 is secured at the base thereof. The fixing element 160 may take the form of a snap ring. However, any suitable arrangement may be used in which the securing element 156 is rotatably retained within the elongate main body 152 of the track connector 150.

At an upper end of the cylindrical main body 160 is formed a hexagonal aperture 164 operable to receive an Allen key or other user-operated device adapted to cause rotation of the securing element 156 to a desired position in use, as described below.

An asymmetric engagement portion 166 is formed on the cylindrical main body 160. By asymmetric is meant that the profile of the engagement portion 166 varies around the perimeter of the engagement portion 166 such that the distance between an outer surface of the engagement portion 166 and the axis Y-Y varies around the perimeter of the engagement portion 166.

In other words, the engagement portion 166 comprises a cam having a cam profile and is arranged, in use, to selectively engage a sidewall of a channel 112, 114. In embodiments, the engagement portion 166 has an elliptical shape. The elliptical shape has technical advantages in that it provides two engagement surfaces which, in use, engage with both opposing sidewalls of a channel 112, 114.

In embodiments, the major and minor axes of the elliptical cam of the engagement portion 166 are selected to ensure robust engagement of and suitable disengagement from the sidewalls of a channel 112, 114. In specific embodiments, where a channel 112, 114 has a width between 12.2 mm and 12.6 mm, the minor axis of the elliptical cam may be in the range of 11 to 11.8 mm and the major axis of the elliptical cam may be in the range of 12.85 mm to 13.25 mm.

However, any suitable shape or form to create some degree of rotational asymmetry about the axis of rotation Y-Y may be used. Suitable variations are described below in relation to FIG. 12A-FIG. 12D.

In embodiments, the securing element 156 may be formed from a suitable metal such as steel. In embodiments, the securing element 156 is formed from cold forged steel. However, other metals may be used such as aluminium or alloys thereof.

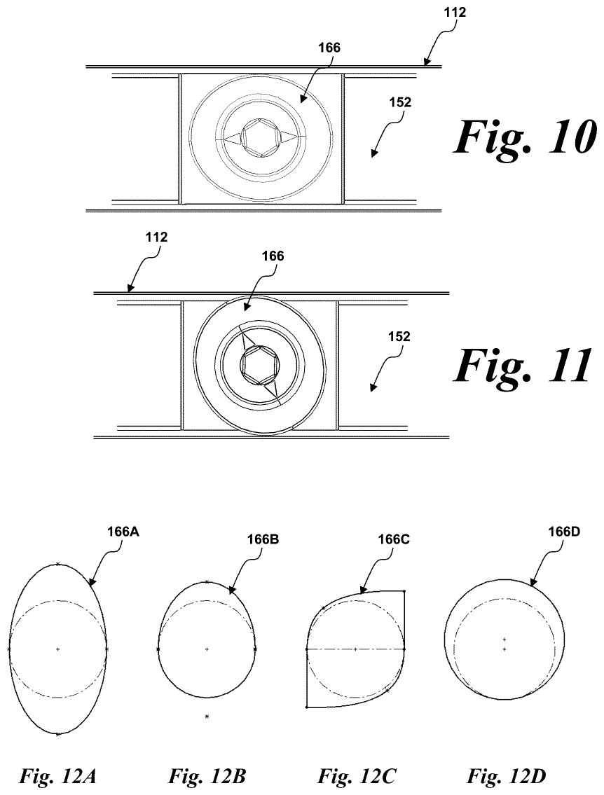

FIGS. 10 and 11 show the operation of the securing element 156 and asymmetric engagement portion 166. FIGS. 10 and 11 show a plan view parallel to the longitudinal axis X-X and perpendicular to the rotational axis Y-Y of part of the track connector 150 when located within channel 112. This would equally apply to channel 114.

FIG. 10 shows the securing element 156 in a first, disengaged, rotational position where the engagement portion 166 is contained within the cross-section of the elongate main body 152 of the track connector 150 and does not extend beyond the lateral extent of the elongate body 152. In this configuration, the track connector 150 is free to slidably move within the channel 112 to enable insertion, positioning or removal.

FIG. 11 shows the securing element 156 in a second, engaged, rotational position in which the engagement portion 166 contacts both sidewalls of the channel 112 and engages therewith. In this configuration, the track connector 150 is retained in the channel 112 to enable the first and second track sections 102, 104 to be securely retained with respect to one another.

Note that only one securing element 156 is shown in FIGS. 10 and 11 for clarity. In the described embodiments, four securing elements 156-1, 156-2, 156-3, 156-4 are provided and each would be rotated to the engaged position to secure the track connector 150 in the channel and retain and connect the first and second track sections 102, 104 to one another.

Further, it is noted that the first and second rotational positions are not discrete and the securing elements 156 may be rotated to any suitable position. Intermediate positions may be possible. In addition, angularly spaced detents may be provided to cause the securing elements to be retained in certain positions which may include the first and second positions.

By providing an engagement portion having an elliptical profile, both sidewalls can advantageously be engaged in the second rotational position. This improves the robustness of the engagement between the track connector 150 and the respective channel 112, 114.

In addition, the elliptical profile provides a suitable cam profile for progressive engagement with the sidewalls of the channels 112, 114 such that the track connector 150 is held securely without slippage. In other words, the ramp angle of the cam profile is suitable for engaging and retaining the track connector 150 in the channel 112, 114.

However, other profiles and configurations of the engagement portion 166 of the securing element 156 may be provided. FIG. 12A-FIG. 12D show four alternative engagement portion structures 166A, 166B, 166C, 166SD suitable for use with embodiments of the present invention.

FIG. 12A shows an elliptical engagement portion 166A profile which has an exaggerated difference between major and minor axes when compared to the example of the first embodiment. This example, being an ellipse, has a rotational symmetry of the order 2 in that the engagement portion 166A is symmetrical through a rotation of 180 degrees. This configuration has the advantage that both sides of a channel 112, 114 can be engaged simultaneously to secure the track connector 150 in situ.

FIG. 12B shows an alternative cam shape and profile for engagement portion 166B in which a circular profile having an extended lobe is provided. This configuration has a rotational symmetry of the order 1, i.e. rotationally asymmetric. This configuration will, in use, only engage with one sidewall of a channel 112, 114.

FIG. 12C shows a further alternative cam shape and profile for engagement portion 166C comprising a snail/drop cam in which a cam ramp is rotationally followed by a sharp drop. This profile is repeated on the opposite side such that the engagement portion 166C is symmetrical through a rotation of 180 degrees. This configuration has the advantage that both sides of a channel 112, 114 can be engaged simultaneously to secure the track connector 150 in situ.

Finally, FIG. 12D shows an engagement portion 166D having a circular profile cam but with the axis of rotation Y-Y offset from the centre of the circle to create an eccentric profile. This configuration has a rotational symmetry of the order 1, i.e. rotationally asymmetric about the axis Y-Y. This configuration will, in use, only engage with one sidewall of a channel 112, 114.

The inventors have found that, for the first time, rotational securing elements 156 can be effectively utilised to secure a track connector 150 within a channel 112, 114. This has the surprising technical effect of being able to retain the track connector 150 within the channel 112, 114 in a robust and reliable manner, connecting the first and second track sections 102, 104 together securely with limited play and with resistance to vibration and other environmental factors that may cause loosening of the connection therebetween, whilst also facilitating straightforward assembly and disassembly of the track sections when required. In addition, this can be achieved with, in embodiments, metal securing elements which further improves the robustness of the connection.

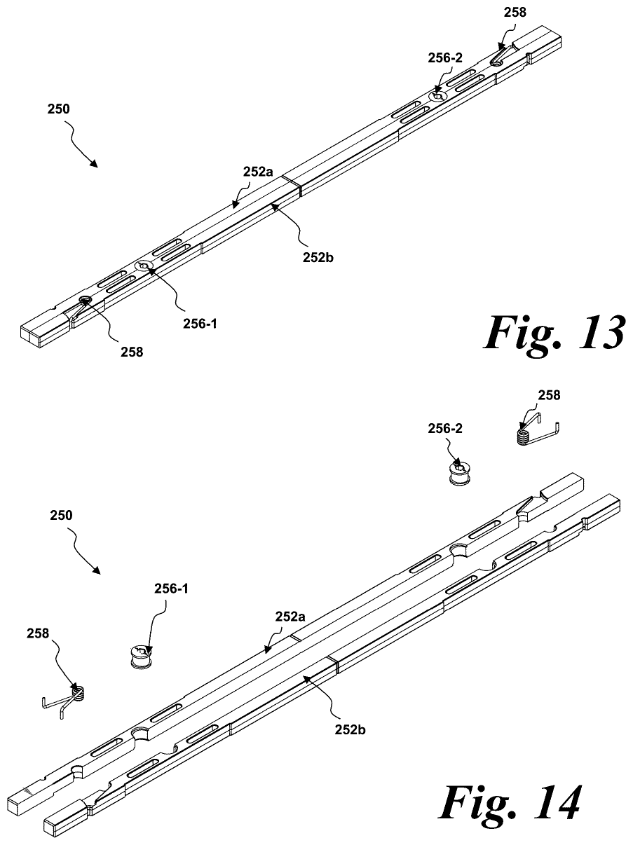

FIGS. 13 and 14 show a second embodiment of track connector 250. The track connector 250 comprises a generally elongate body having first and second sections 252a, 252b each having a rectangular cross section. The elongate body sections 252a, 252b are formed from a suitable material such as metal (for example, steel or aluminium) or a plastics material. However, any suitable material may be used.

The elongate body sections 252a, 252b of the track connector 250 are dimensioned and arranged such that, in a first configuration, they fit slidably within one of the channels 112, 114 as shown in FIGS. 1 to 5. By slidably fitted within a channel 112, 114 is meant that the track connector 250 is dimensioned and arranged such that it is smaller in cross section than the channels 112, 114 such that the track connector 250 may slide back and forth within the channel(s) 112, 114 without significant force being required, i.e. the fit is not frictional.

As for the first embodiment, because the track connector 250 is slidably received in a channel 112, 114 for convenience of assembly, it is necessary to further secure the track connector 250 within a channel 112, 114 so that each track section 102, 104 is prevented from moving relative to one another in a direction parallel to the axis X-X, and so that the track sections 102, 104 are robustly retained as a unit without significant play therebetween.

To achieve this, rotary securing elements 256 are provided along the length of the track connector 150. In embodiments two rotary securing elements 256-1, 256-2 are provided on each track connector 150. However, any suitable number of securing elements may be provided as required.

The second embodiment differs from the first embodiment in that the securing elements 256 themselves do not engage with the sidewalls of the channels 112, 114. Instead, the rotary securing elements 256-1, 256-2 change the spacing between the first and second elongate body sections 252a, 252b which selectively engage or disengage with the sidewalls of the respective channel 112, 114.

In order to achieve this, the rotary securing elements 256 have an axis of rotation Y-Y and at least one surface which is asymmetric with respect to the axis of rotation Y-Y such that in a first rotational position the track connector 250 is free to move along the channel 112, 114 and in a second rotational position the track connector 250 is retained in the respective channel 112, 114.

In order to facilitate the transition between a first disengaged rotational position and a second engaged rotational position, two spring elements 158, 158 are provided. Spring elements 158 resiliently bias the first and second elongate body sections 252a, 252b towards one another.

It is noted that the first and second rotational positions are angularly spaced but not discrete and the securing elements 256 may be rotated to any suitable position. Intermediate positions may be possible. In addition, angularly spaced detents may be provided to cause the securing elements to be retained in certain positions which may include the first and second positions.

In embodiments, the present invention enables a track connector to be used and secured to connect two track sections in a convenient and quick manner. In embodiments, a rotary securing element is rotatable to cause a part of the track connector to selectively engage or disengage a sidewall of a channel in which it is contained therein. This has significant advantages over, for example, using grub screws or other securing means which may cause damage to parts of the track guide 100 and may wear or loosen over time.

Variations of the above embodiments will be apparent to the skilled person. The precise configuration of components may differ and still fall within the scope of the present invention.

For example, whilst two embodiments of rotary securing elements have been described, these are not intended to be limiting and other configurations may be possible.

Embodiments of the present invention have been described with particular reference to the examples illustrated. While specific examples are shown in the drawings and are herein described in detail, it should be understood, however, that the drawings and detailed description are not intended to limit the invention to the particular form disclosed. It will be appreciated that variations and modifications may be made to the examples described within the scope of the present invention.

1. A track guide for a cutting saw power tool, the track guide being arranged in use to engage with a cutting saw power tool such that the cutting saw power tool is operable to slide back and forth in a longitudinal direction along the track, the track guide comprising:
first and second track sections, each track section having at least one longitudinal channel arranged substantially parallel to the longitudinal direction; and
at least one track connector, the or each track connector comprising an elongate main body configured and arranged such that, in use, a first portion of the elongate main body is received within a longitudinal channel of the first track section and a second portion of the elongate main body of the track member is received within a corresponding longitudinal channel of the second track section in order to connect the first and second track sections in a longitudinal direction;
wherein each track connector comprises at least one rotary securing element comprising an engagement portion having a cam profile, wherein the or each rotary securing element is selectively rotatable about an axis of rotation between a first rotational orientation in which the track connector is free to move with respect to the respective longitudinal channel and a second rotational orientation in which the track connector is releasably engaged with one or more walls of a respective channel such that the track connector is held within the respective channel.

2. A track guide according to claim 1, wherein the first and second rotational orientations are angularly spaced by 90 degrees or less.

3. A track guide according to claim 1, wherein the engagement portion of the or each rotary securing element is spaced from one or more walls of the respective channel in the first rotational orientation.

4. A track guide according to claim 1, wherein the engagement portion of the or each rotary securing element is configured and arranged to engage directly with one or more of the walls of the respective channel in the second rotational orientation.

5. A track guide according to claim 4, wherein the engagement portion of the or each rotary securing element is configured and arranged to engage directly with two opposing walls of the respective channel in the second rotational orientation.

6. A track guide according to claim 1, wherein the elongate main body comprises first and second portions, and wherein the engagement portion of the or each rotary securing element is operable, in the second rotational orientation, to cause the first and second portions to engage with one or more of the walls of the respective channel.

7. A track guide according to claim 1, wherein the engagement portion of the or each rotary securing element has a cam profile having rotational symmetry of the order of one or two.

8. A track guide according to claim 1, wherein the engagement portion of the or each rotary securing element has an elliptical cam profile.

9. A track guide according to claim 1, wherein the engagement portion of the or each rotary securing element has a circular cam profile having a centre offset from the axis of rotation of the respective rotary securing element.

10. A track guide according to claim 1, wherein the or each rotary securing element is located in a respective recess formed in the elongate main body.

11. A track guide according to claim 1, wherein a plurality of rotary securing elements are provided on each track connector.

12. A track connector for connection of first and second sections of a track guide for a cutting saw power tool, the track guide being arranged in use to engage with a cutting saw power tool such that the cutting saw power tool is operable to slide back and forth in a longitudinal direction along the track guide, the first and second track sections each having at least one longitudinal channel arranged substantially parallel to the longitudinal direction, wherein the track connector comprises:
an elongate main body configured and arranged such that, in use, a first portion of the elongate main body is received within a longitudinal channel of the first track section and a second portion of the elongate main body is received within a corresponding longitudinal channel of the second track section in order to connect the first and second track sections in a longitudinal direction; and
at least one rotary securing element comprising an engagement portion having a cam profile, the or each rotary securing element being selectively moveable between a first rotational orientation in which, in use, the track connector is free to move with respect to the respective longitudinal channel and a second rotational orientation in which, in use, the track connector is releasably engaged with a sidewall of a respective channel such that the track connector is held within the respective channel.

13. A track connector according to claim 12, wherein the first and second rotational orientations are angularly spaced by 90 degrees or less.

14. A track connector according to claim 12, wherein the engagement portion of the or each rotary securing element is spaced from one or more walls of the respective channel in the first rotational orientation.

15. A track connector according to claim 12, wherein the engagement portion of the or each rotary securing element is configured and arranged to engage directly with one or more of the walls of the respective channel in the second rotational orientation.

16. A track connector according to claim 15, wherein the engagement portion of the or each rotary securing element is configured and arranged to engage directly with two opposing walls of the respective channel in the second rotational orientation.

17. A track connector according to claim 12, wherein the elongate main body comprises first and second portions, and wherein the engagement portion of the or each rotary securing element is operable, in the second rotational orientation, to cause the first and second portions to engage with one or more of the walls of the respective channel.

18. A track connector according to claim 12, wherein the engagement portion of the or each rotary securing element has a cam profile having rotational symmetry of the order of one or two.

19. A track connector according to claim 12, wherein the engagement portion of the or each rotary securing element has an elliptical cam profile.

20. A track connector according to claim 12, wherein the engagement portion of the or each rotary securing element has a circular cam profile having a centre offset from the axis of rotation of the respective rotary securing element.

21. A track connector according to claim 12, wherein the or each rotary securing element is located in a respective recess formed in the elongate main body.

22. A track connector according to claim 12, wherein a plurality of rotary securing elements are provided on each track connector.
